(19) United States
(12) Patent Application Publication
(10) Pub. No.: US 2018/0354300 A1
(43) Pub. Date: Dec. 13, 2018

(54) MOTOR VEHICLE TOOL

(71) Applicant: Ford Global Technologies, LLC, Dearborn, MI (US)

(72) Inventors: Wenping Tian, Nanjing (CN); Zhenhong Ge, Nanjing (CN)

(73) Assignee: Ford Global Technologies, LLC, Dearborn, MI (US)

(21) Appl. No.: 16/005,930

(22) Filed: Jun. 12, 2018

(30) Foreign Application Priority Data
Jun. 13, 2017 (CN) 201710444055.5

(51) Int. Cl. B60B 29/00; B66F 13/00; B25G 1/06; B25B 13/06

(52) U.S. Cl. CPC B60B 29/003; B25B 13/06; B25G 1/063; B66F 13/00

(57) ABSTRACT

A tool for use with a vehicle jack or vehicle wheel fastener including an operation shank, a first segment and a second segment. The first segment may include a connection end coupled to the operation shank, a distal end spaced from the operation shank, and a first slot extending longitudinally in a first direction. The second segment may include a first end and a second end opposite to the first end, with the second segment movably connected to the first segment. The second segment movable in the first direction so the first end of the second segment extends beyond the distal end of the first segment and the second segment is movable in a second direction opposite to the first direction so the second end extends beyond the connection end.

### CROSS-REFERENCE TO RELATED APPLICATIONS

Not Applicable.

### BACKGROUND OF THE INVENTION

### 1. Field of the Invention

A motor vehicle tool; and more specifically, a tool for operating a vehicle jack and tightening or loosening vehicle wheel fasteners.

### 2. Description of Related Art

Some vehicles are provided with a jack and a wrench for lifting heavy objects or for emergency use, such as, changing a spare tire. It can be challenging for a user to unscrew the lug nuts or operate the jack. Various types of wrenches are used as a tool for operating the jack. For instance, a wrench is configured to have multiple segments that can be joined to add a length and hence can increase the moment arm so the user can apply a smaller force to operate the tool.

### SUMMARY OF THE INVENTION

A tool including an operation shank and a first segment including a connection end coupled to the operation shank, a distal end spaced from the operation shank, and a first slot extending longitudinally in a first direction. The tool including a second segment including a first end and a second end opposite the first end, the second segment movable in relation to the first segment in the direction of the first slot and wherein the second segment moves in the first direction, so the first end extends beyond the distal end of the first segment, and the second segment is movable in a second direction opposite to the first direction so the second end extends beyond the connection end.

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

### BRIEF DESCRIPTION OF THE DRAWINGS

The present invention will become more fully understood from the detailed description and the accompanying drawings, wherein:

FIG. 1 is a perspective view of a tool in a first use position according to one embodiment of the present disclosure.

FIG. 2 is a perspective view of the tool illustrated in FIG. 1 in a second use position.

FIG. 3A is a perspective view of the tool illustrated in FIG. 1 in a third use position.

FIG. 3B is a perspective view of the tool illustrated in FIG. 3A viewed from a different angle.

FIG. 4 is a partially enlarged side view of the tool illustrated in FIG. 1.

FIG. 5A and FIG. 5B are perspective views of a connector in the tool according to one embodiment of the present disclosure.

FIG. 6 is a perspective view of a tool in a first use position according to another embodiment of the present disclosure.

FIG. 7 is a perspective view of the tool illustrated in FIG. 6 in a second use position.

FIG. 8 is a perspective view of the tool illustrated in FIG. 6 in a third use position.

FIG. 9 is a perspective view of the tool illustrated in FIG. 6 in a fourth use position.

FIGS. 10A and 10B are an enlarged perspective view of various embodiments of a connector.

### DETAILED DESCRIPTION OF THE PREFERRED EMBODIMENTS

The following description of the preferred embodiment(s) is merely exemplary in nature and is in no way intended to limit the invention, its application, or uses.

The figures are intended to illustrate the general characteristics of methods, structures and/or materials utilized in certain example embodiments and to supplement the written description provided below. These drawings are not, however, to scale and may not precisely reflect the precise structural or performance characteristics of any embodiment and should not be interpreted as defining or limiting the range of values or properties encompassed by example embodiments. Using similar or identical reference numbers in the drawings indicates the presence of a similar or identical element or feature.

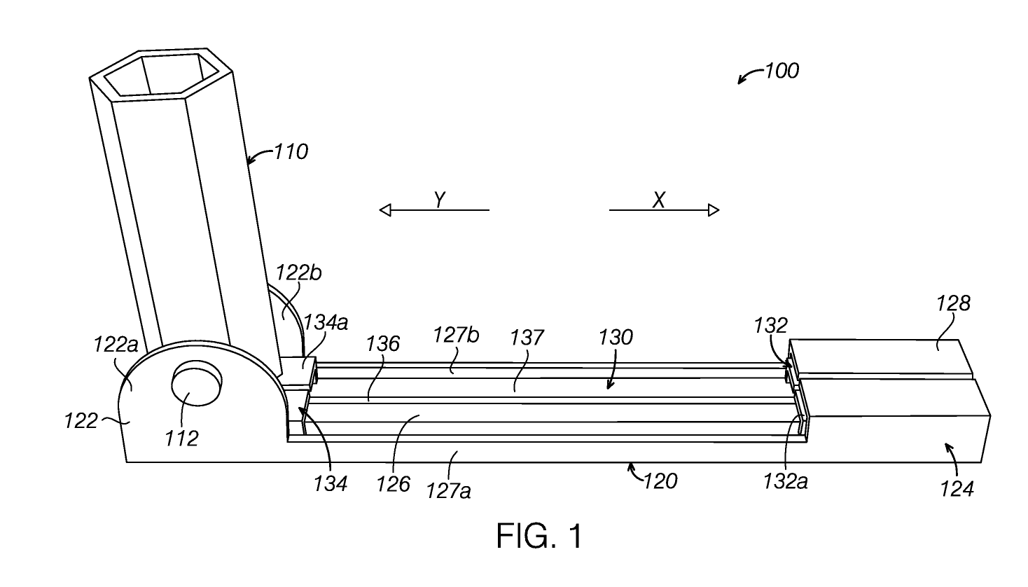

FIG. 1 is a perspective view of a tool 100 according to one embodiment of the present disclosure, illustrating the tool 100 in a first use position. The tool 100 includes an operation shank 110, a first segment 120 connected to the operation shank 110, and a second segment 130. In the first use position, the tool 100 substantially exhibits a first L shape. The second segment 130 is substantially contained or received in the first segment 120. The first segment 120 includes a connection end 122 coupled to the operation shank 110 and a distal end 124 away from the operation shank 110. FIG. 1 shows a pivot 112 pivotally connecting the operation shank 110 to the connection end 122 of the first segment 120. The pivot 112 enables rotation of the operation shank 110 to a position closer to the first segment 120 and the second segment 130, so the tool 100 occupies a relatively small space in a stowed position when stored or not in use. In one embodiment the pivotal connection is unnecessary and the operation shank 110 may be fixedly connected to the connection end 122.

In the embodiment depicted in FIG. 1, the operation shank 110 is shown to include a hexagon socket to hold a head of a fastener. A cross-section of the socket of the operation shank 110 may have dimensions and shapes dependent on the fastener to be held. In other embodiments, the operation shank 110 may include a magnetic inner wall and may receive fasteners or connectors having different shapes.

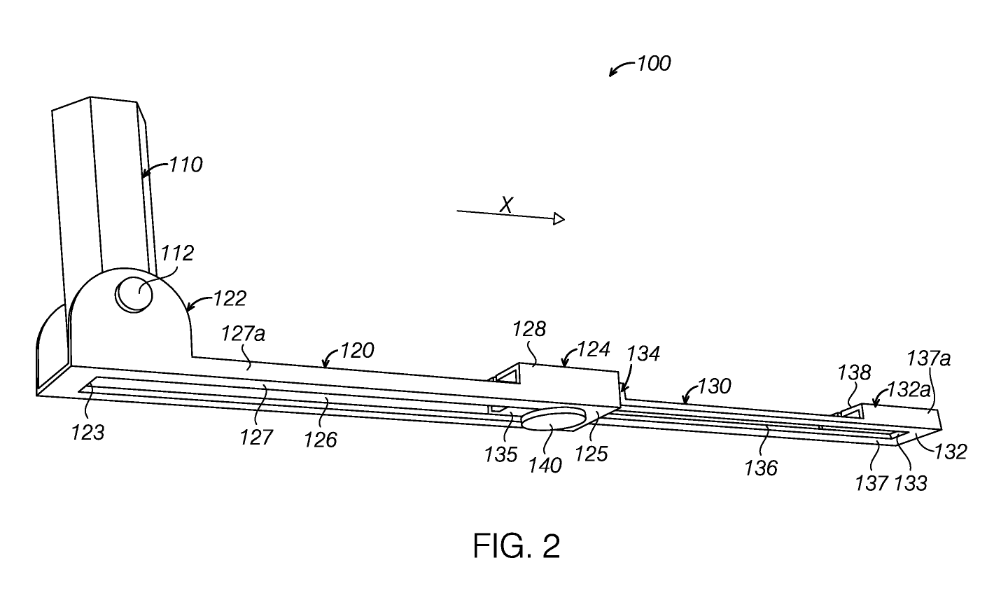

FIG. 2 depicts the tool 100 in FIG. 1, illustrating the tool 100 in a second use position. The tool 100 has a second, extended L shape and in the second use position, the second segment 130 extends along a first direction X, corresponding to a longitudinal direction of the first segment 120 and the second segment 130, wherein the tool 100 has an extended length. The tool 100 in the second use position provides a larger torque compared to the first use position when an applied force is the same. Referring to FIG. 1 and FIG. 2, in one embodiment, the first segment 120 includes a first slot 126 extending in the first direction X. In the depicted embodiment, the first slot 126 substantially extends in the first direction X or the longitudinal direction of the first segment 120. The second segment 130 includes a first end 132 and an opposed second end 134. The second segment 130 is disposed on the first slot 126 and moves relative to the first segment 120 along the first direction X so the first end 132 extends beyond the distal end 124 of the first segment 120. The second segment 130 may include a second slot 136 extending substantially parallel to the first slot 126. The tool 100 further includes a connector 140 extending between the first slot 126 and the second slot 136.

FIG. 2 shows the second use position of the second segment 130 extended in the first direction X. In the second use position, the arm of the tool 100, formed by a sum of the lengths of first segment 120 and the second segment 130, is the longest. The length from the first end 132 to the operation shank 110 is maximum and the second use position may be a terminal position at which further movement in the direction X is restricted. When using the tool 100 the second segment 130 may move to any position along the first segment 120 in the first direction X, including any position between the first use position in FIG. 1 and the second use position in FIG. 2. The first end 132 of the second segment 130 may have a variable distance to the operation shank 110. Variable distance or variable moment arms of the tool may provide additional operational flexibility. For instance, while unscrewing a bolt on a wheel at the beginning when the tool is further away from the ground, a user may desire a greater moment arm. When the tool is rotated to a position closer to the ground, the length of the tool can be adjusted to avoid interference with the ground, and it is not necessary to disengage the operation shank 110 from the wheel bolt to complete the above step of adjusting the moment arm.

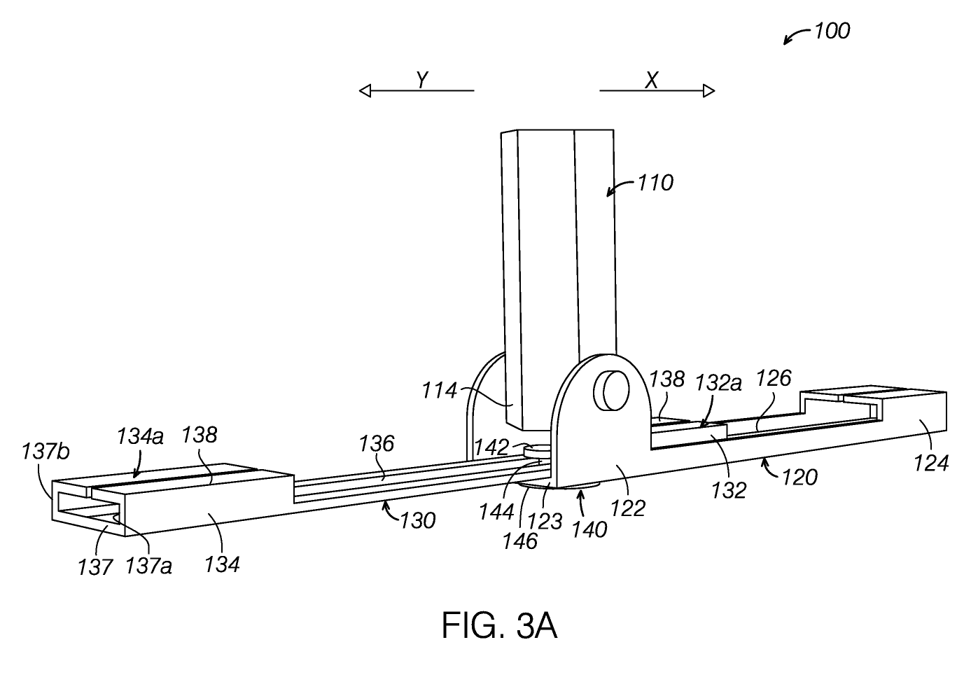

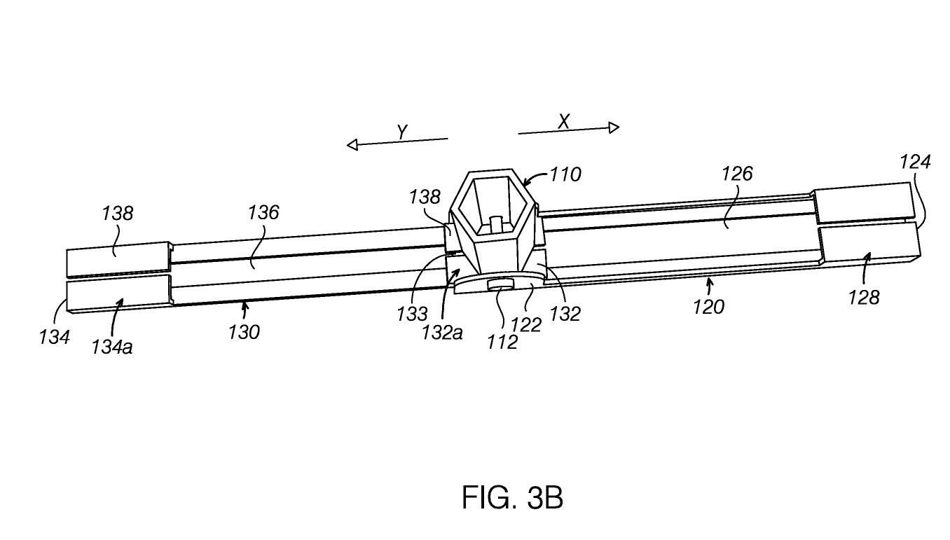

FIG. 3A shows the tool 100 in a third use position and FIG. 3B shows another view of the tool 100 in the third use position. As shown in FIG. 3A and FIG. 3B, the tool 100 generally exhibits a T shape. Referring to FIG. 1 through FIG. 3B, the second segment 130 may slide in a second direction Y opposite to the first direction X wherein the second end 134 of the second segment 130 extends beyond the connection end 122, or the operation shank 110. FIG. 3A and FIG. 3B show a terminal position. However, the second segment 130 may extend in the second direction Y a suitable distance so the second end 134 of the second segment 130 may have a variable length relative to the connection end 122 of the first segment 120. The connection end 122, the distal end 124, the first end 132 and the second end 134 may have any dimension and configuration.

In another embodiment, the first segment 120 and the second segment 130 are connected via a connector 140 defining a terminal position of the second segment 130, a position preventing the first segment 120 from being disengaged from the second segment 130 or restricting further movement in one direction.

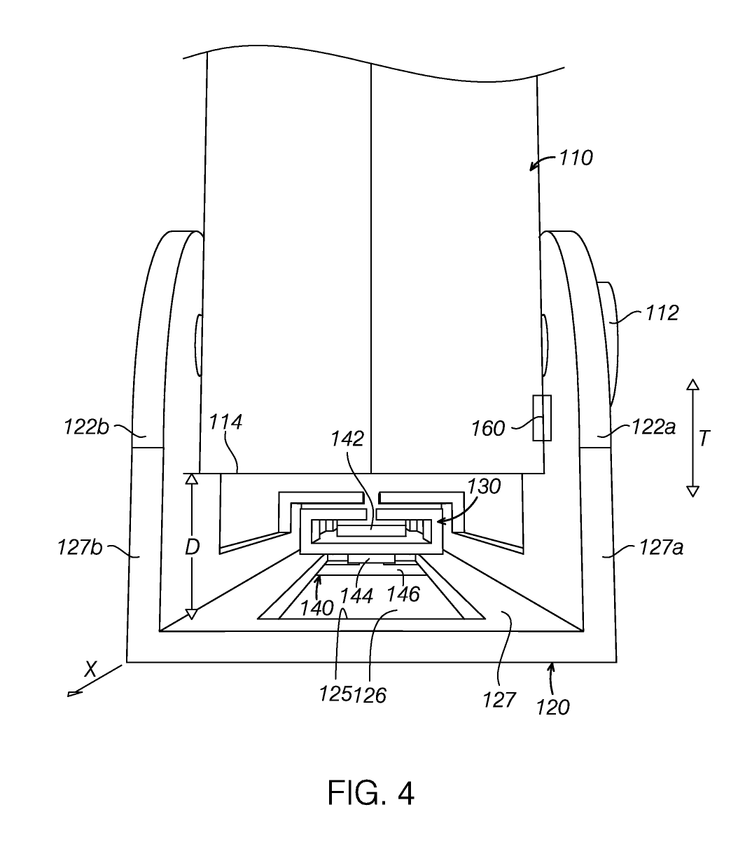

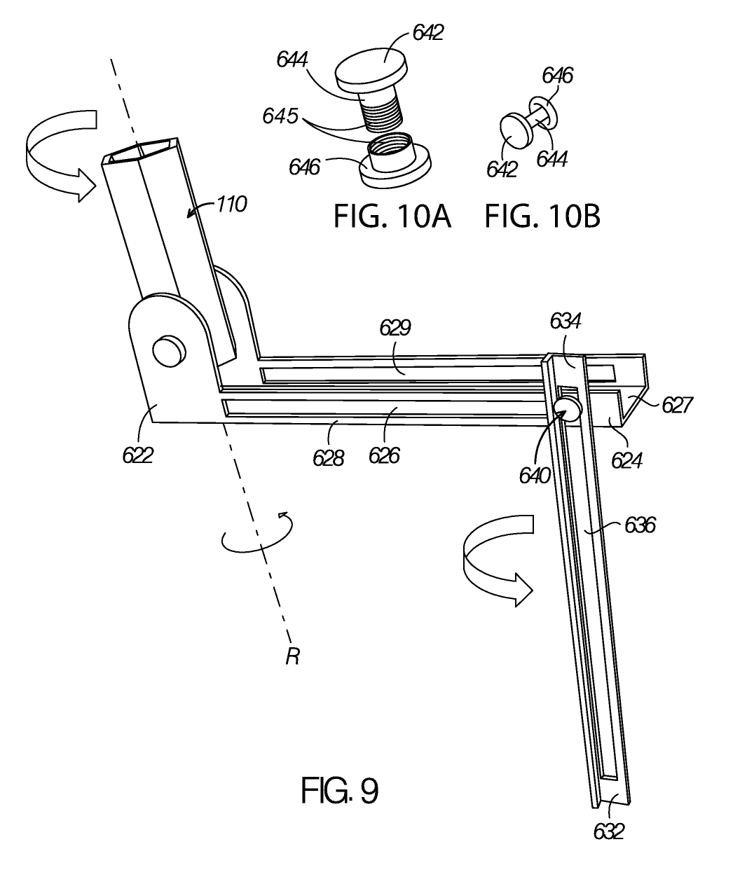

Referring to FIG. 4, in one example, the connector 140 has a neck 144 received in the first slot 126 and the second slot 136, a head 142 and a tail 146 connected to the neck 144. A dimension of the head 142 and the tail 146 in one direction is larger than a width of the first slot 126 and a width of the second slot 136 retaining the connector 140 in the first slot 126 and the second slot 136. The connector 140 may be formed several ways, for example, the parts of the connector 140 may be formed separately and then joined via snap fit, see FIG. 10B or screwed together, see FIG. 10A. In another instance, a body could be preassembled and then punched to form the head 142 or the tail 146. Forming separated parts for the connector 140 may provide convenience for assembly. For example, the connector 140 may be formed from separated parts and then joined through screw connections. Using a screw connection, see for example FIG. 10A enables the connector 140 to move freely by loosening the screw connection and the first segment 120 and the second segment 130 may be relatively fixed at any position by tightening the screw connection. In one embodiment, the first segment 120 and the second segment 130 may be relatively locked at any position by adjusting the clearance between the neck of the connector and the first slot and the second slot. For instance, tight engagement or interference tolerance between the neck of the connector and the first slot and between the neck and the second slot may allow the first segment and the second segment to be relatively fixed at a middle position between the terminal positions, and the first segment and the second segment are movable relative to each other by applying a predetermined force.

FIG. 4 is a partially enlarged view of the tool 100 in FIG. 1 with the location and function of the connector 140 understood upon referring to FIG. 1 through FIG. 4. In one or more embodiments, the head 142 of the connector 140 is generally located outside of the second slot 136, while the tail 146 of the connector 140 is generally located outside of the first slot 126. The head 142 being outside of the second slot 136 means that the head 142 is exterior to a plane of the second slot 136 facing the operation shank 110 and the tail 146 being outside of the first slot 126 means that the tail 146 is exterior to a plane of the second slot 136 away from the operation shank 110.

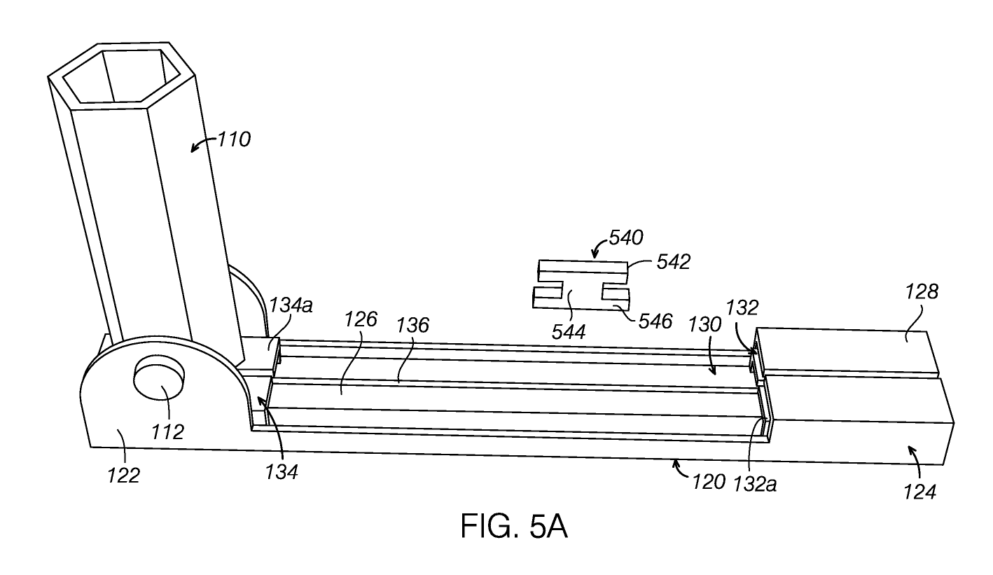

FIG. 5A to FIG. 5B illustrate examples of a connector 540 according to another embodiment of the present disclosure. The connector 540 has a different shape. Specifically, the connector may have an “H” shape. Similar parts are omitted for brevity. A head 542 and a tail 546 of the connector 540 are configured whereby the connector 540 moves in the first slot 126 and the second slot 136 when a main surface of the connector 540 is at a first angle to the first slot 126 and the second slot 136 in FIG. 5A. The first angle could be the main surface of the connector 540, the main surface in a plane shared among the head 542, the neck 544 and the tail 546, being substantially parallel to the first slot 126 and the second slot 136, or an angle allowing the connector 540 to pass through the first slot 126 and the second slot 136. As shown in FIG. 5B, when the tail 546 passes through the first slot 126 and the second slot 136 while the head 542 is outside the plane of the first slot 126 the connector 540 may rotate to a second angle different from the first angle, with a width W of the head 542 and the tail 546 of the connector 540 being larger than a width of the first slot 126 and a width of the second slot 136 so the connector 540 is retained in the first slot 126 and the second slot 136 and would not be disengaged from the first slot 126 and the second slot 136.

FIG. 1 through FIG. 5B show, in one or more examples, the connector 140 or 540 may prevent the first segment 120 from being disengaged from the segment 130. As shown in FIG. 2, the first slot 126 extends between the connection end 122 and the distal end 124. A length of the first slot 126 is defined by an inner edge 123 at the connection end 122 and an outer edge 125 at the distal end 124. The second slot 136 extends between the first end 132 and the second end 134. A length of the second slot 136 is defined by a first edge 133 at the first end 132 and a second edge 135 at the second end 134. When the second segment 130 moves in the first direction X to the first position in FIG. 2, the neck 144 of the connector 140 contacts the outer edge 125 of the first segment and the second edge 135 of the second segment so the second segment 130 cannot move thereby preventing the second segment 130 from being disengaged from the first segment 120 in the direction X. When the second segment 130 moves along the first direction X from the position in FIG. 1 to the first use position in FIG. 2 the connector 140 is held between the outer edge 125 and the second edge 135, and the neck 144 at a front of the second end 134 of the second slot 130 prevents the second segment 130 from moving further in the first direction X. When the second segment 130 moves in the second direction Y to the third use position in FIGS. 3A-3B, the neck 144 of the connector 140 contacts the inner edge 123 of the first slot 120 and the first edge 133 of the second slot 130 to restrict further movement of the second segment 130 in the second direction Y preventing the second segment 130 from being disengaged from the first segment 120. The third use position may be a terminal position at which further movement at the direction Y is restricted. The neck 144 of the connector is held between the inner edge 123 and the first edge 133. In one or more examples, the tool 100 includes a lock mechanism retaining the second segment 130 in the first, second or the third use position or other use positions. Specifically, in one example, the first edge 133 and the second edge 135, the inner edge 123 and the outer edge 125 may have a relatively large thickness in the direction T and clearance with the connector 140 may be controlled at the first use position and the second use position. A relatively smaller clearance or interference fit may improve the stability at the first or second positions. In other examples, the tool 100 may further include a lock mechanism or device to retain the second segment 130 at other positions different from the first, second and the third use positions.

Continuing with FIG. 1 to FIG. 5B, in one embodiment, the first segment 120 includes a bottom wall 127 extending along the first direction X with a first sidewall 127a and an opposing second sidewall 127b connected to the bottom wall 127. The first slot 126 is formed on the bottom wall 127 of the first segment 120. The second segment 130 includes a bottom wall 137 extending along the first direction X, and the second slot 136 is formed on the bottom wall 137 of the second segment 130. The bottom wall 127 of the first segment 120 and the bottom wall 137 of the second segment 130 are substantially parallel to each other. The connection end 122 includes support walls 122a and 122b extending from the first sidewall 127a and the second sidewall 127b in a direction away from the bottom wall 127. The operation shank 110 is pivotably connected to the two supporting walls 122a and 122b. At the use positions, the operation shank 110 is connected to the two supporting walls 122a and 122b in such a manner that a bottom 114 of the operation shank 110 is at a predetermined distance D from the bottom wall 127 of the first segment 120 allowing the second segment 130 to pass through. Specifically, the distance D allows the second end 134 of the second segment 130 to slide relative to the first segment 120 in the second direction Y from the position in FIG. 1 and pass through a space defined by the distance D and beyond the connection end 122 to reach a position in FIG. 3A. Further, the distance D is configured so the operation shank 110 may pivot to a position close to the first segment or a position that the distal end of the operation shank 110 is adjacent to the first segment.

In one embodiment, the second segment 130 may slide relative to the first segment 120 to a position at which it is completely received in the first segment 120. “Completely received” means that when the second segment 130 is received in the first segment 120, the length of the arm of the tool at the direction X is the length of the first segment 120.

Continuing with FIG. 1 through FIG. 5B, in one embodiment, the distal end 124 of the first segment 120 further includes a distal handle 128 having a certain length in the direction X. The handle 128 in a plane parallel to the bottom wall 127 by folding a portion of the first sidewall 127a and a portion of the second sidewall 127b towards each other to have a surface substantially parallel to the bottom wall 127. In a plane perpendicular to the first direction X, the distal handle 128 has a rectangular section that is not completed closed. In another embodiment, the first end 132 and the second end 134 of the second segment 120 respectively has a first handle portion 132a and a second handle portion 134a. The first and second handle portions 132a and 134a include a bottom wall 137, two side walls 137a, 137b and a top wall 138. In the plane perpendicular to the first direction X the first and second handle portions 132a, 134a include rectangular cross-sectional sections that are not completed closed, the cross-sectional section is not a closed loop. In other embodiments, the handle portions may form a closed loop at the cross-section. The handle or handle portions are configured for easy grasping by a user. The shape and dimension of the handle may vary as necessary. In one embodiment, sleeves made from other materials such as plastic or rubber may be wrapped to the handles to improve the user experience. In some embodiments, the tool 100 itself may be formed of metal and may be over-molded with plastic or other soft material layers to reduce noise.

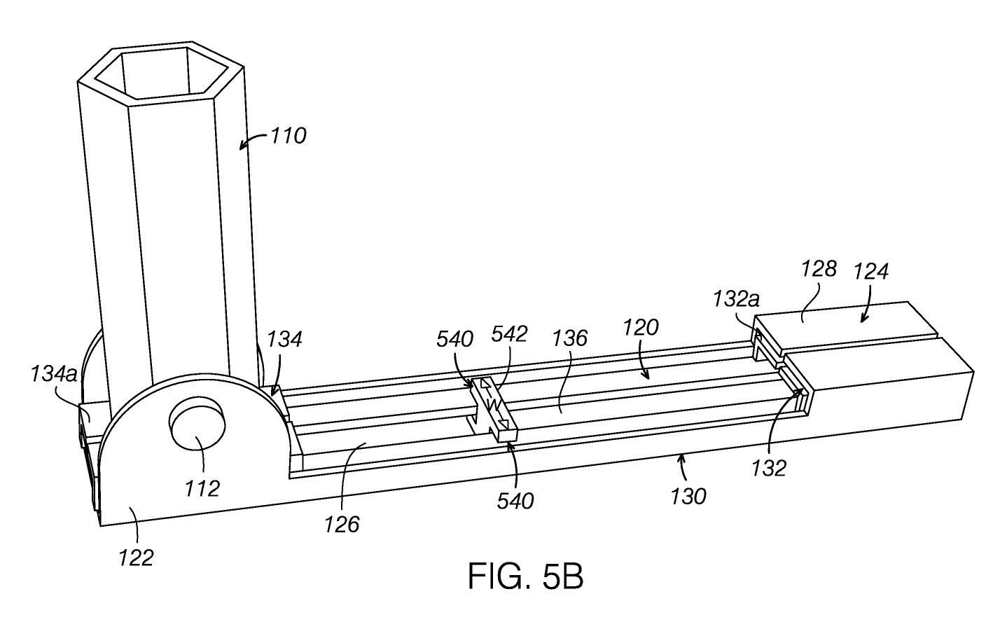

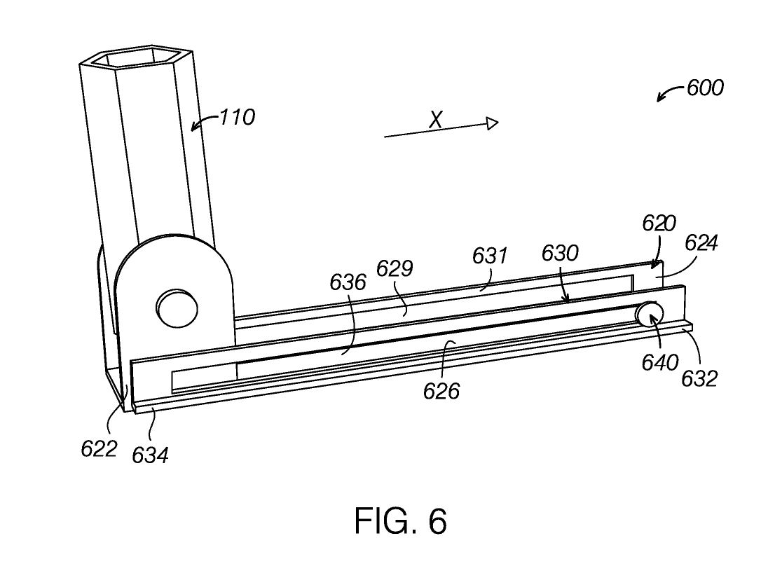

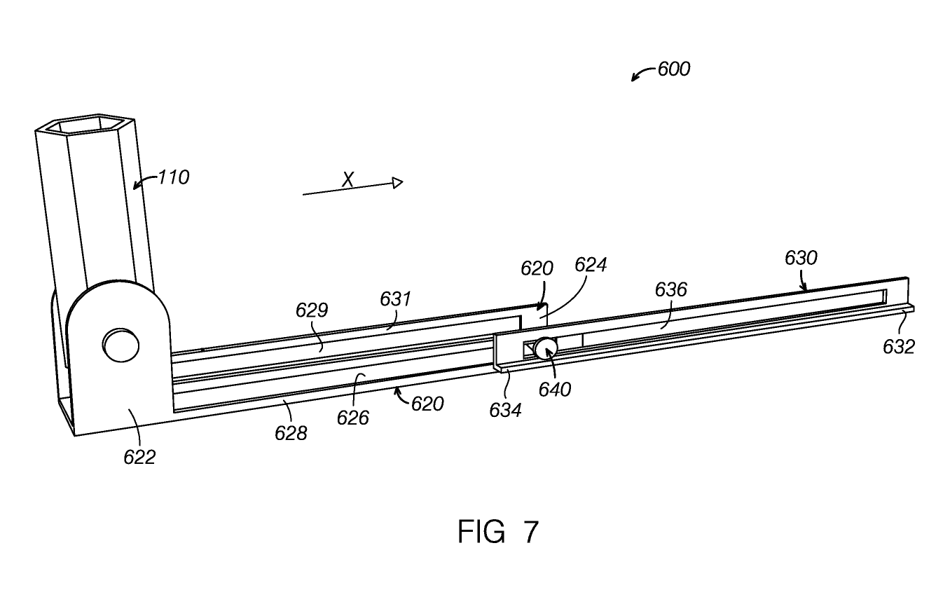

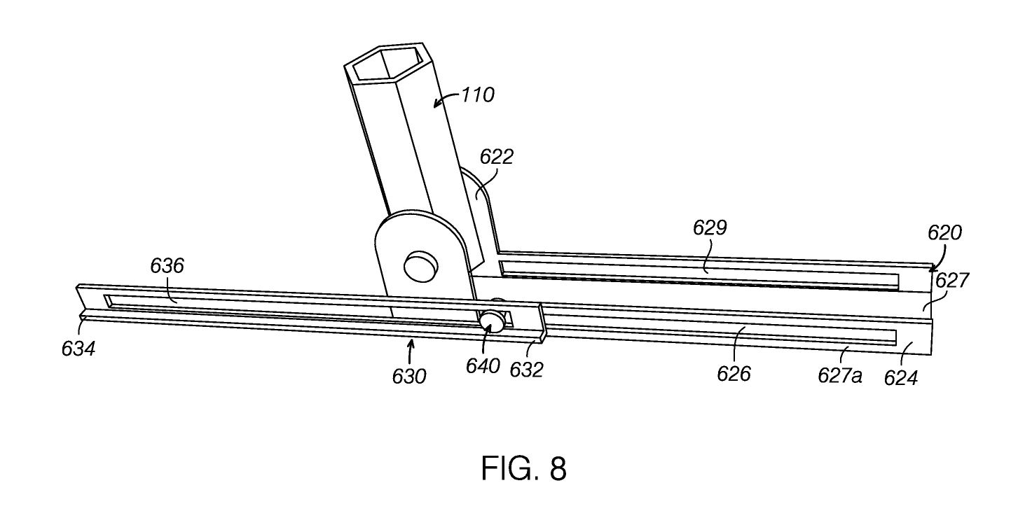

FIG. 6 through FIG. 9 illustratively depict a tool 600 according to another embodiment of the present disclosure. The tool 600 includes an operation shank 110 to accommodate a fastener; a first segment 620 and a second segment 630 and a connector 640 to couple the first segment 620 and the second segment 630. The tool 600 has multiple use positions. FIG. 6 illustrates a first use position where the second segment 630 is completely received in the first segment 620. In the first use position, the tool 600 exhibits an L shape or a first L shape and has a smallest moment arm. FIG. 7 illustrates a second use position of the tool 600 having an extended L shape or a second L shape with an increased moment arm. FIG. 8 illustrates a tool 600 at a third use position having a T shape. FIG. 9 illustrates a fourth use position of the tool 600. In the embodiment in FIG. 6 through FIG. 9, the first segment 620 of the tool 600 includes a connection end 622 coupling the operation shank 110 and a distal end 624 spaced from the operation shank 110. The first segment 620 includes a first slot 626 between the connection end 622 and the distal end 624 and extends along the first direction X. The second segment 630 has a first end 632, a second end 634 and a second slot 636 extending between the first end and second end 634. The second end 634 is close to the connection end 622 of the first segment 620 at the first use position. The second segment 630 is connected to the first slot 626 so the second segment 630 may move in the first direction X and a second direction Y opposing the first direction. At the use positions, the operation shank 110 is perpendicular to the first segment 620 or forms any appropriate angles to the first segment 620. The angles of substantially 90 degrees between the operation shank 110 and first segment 620 may facilitate more efficient torque application or may be more stable. It should be appreciated that other angles between the operation shank 110 and first segment 620 may be used during the operation. As shown in FIG. 6, at the first use position, the second segment 630 and the first segment 620 may be substantially overlapped to form a first L shape. At the second use position in FIG. 7, the first end 632 of the second segment 630 extends beyond the distal end 624 and forms a second L shape with an extended length to increase a moment arm relative to the connection end. When a larger torque is needed, the extended L shape can be employed. At the third use position in FIG. 8, the second end 634 of the second segment 630 slides beyond the connection end 110 to form a T shaped tool to enable a user to operate the tool 200 conveniently with both hands.

In the embodiment in FIG. 6 through FIG. 9, the first segment 620 includes a bottom wall 627 and a side wall 628. The first slot 626 is formed on the side wall 628, and a plane of the second slot 636 is substantially parallel to a plane of the first slot 626. The second segment 630 is slidably connected to the side wall 628 via a connector or pivot 640. The respective first and second segments 620, 630 are pivotally joined by the connector or pivot 640. The connector or pivot 640 moves in the first slot 626 and the second slot 636 so the second segment 630 is movable relative to the first segment 620 to vary the length of the arm in the direction X. Further, the second segment 630 is pivotable to the first segment 620 to vary an angle between the first segment 620 and the second segment 630.

As shown in FIG. 10A the connector or pivot 640 has a shaft 644 received in the first slot 626 and the second slot 636, a head 642 and a tail 646 which prevent the shaft 644 from being disengaged from the first slot 626 and the seconds slot 636. In some embodiments, at least one of the head 624 and tail 644 is connected to the shaft 644 via threads 645, and the connector or pivot 640 can move freely by loosening the thread connection. The first segment 620 and the second segment 630 may be relatively fixed at any position by tightening the thread connection, and the connector or pivot 640 clamping the edges of the first slot 626 and the second slot 636. Besides the first to third use positions described above, the tool 600 can provide an additional fourth use position. Specifically, at the fourth use position in FIG. 9, the second end 634 of the second segment 630 is adjacent to the distal end 624 of the first segment 620, and the first end 632 is away from the distal end 624. The operation shank 110, the first segment 620 and the second segment 630 may form a Z shape. As shown in FIG. 9 the operation shank 110, the first segment 620, and the second segment 630 may be perpendicular to each other. By grabbing the second segment 630 and moving the first segment around a central axis R of the operation shank, the operation shank 110 may easily loosen or tighten a fastener. Referring to FIGS. 6, 7, in one embodiment, the first segment may include a second side wall 631 substantially parallel to the first side wall 628, and the second side wall 631 includes an auxiliary slot 629, a user may fix the second segment 630 to the first slot 626 or the auxiliary slot 629 via the connector or pivot 640. In another example, the shaft 644 of the connector or pivot 640 may pass through the first slot 626, the second slot 636 and the auxiliary slot 629, while the head 642 and the tail 646 are respectively located outside the second slot 636 and the auxiliary slot 629. It should be appreciated that auxiliary slot 629 may not be necessary. As shown in FIG. 10B the connector or pivot may be press fit with the shaft 644 frictionally received in an opening in the tail 646. As disclosed, other methods for joining the respective head 642 and tail 646 of the connector 640 may also be used.

One or more embodiments of the present disclosure provide a tool to tighten, loosen or hold a fastener. In one embodiment, the tool may be used as a wrench for a jack to loosen or tighten a bolt of the tire or to engage a jack to operate and correspondingly cause the jack to lift. The tool may include an operation shank includes a section to receive the fastener, a first segment, and a second segment. The first segment may have a connection end coupled to the operation shank, a distal end away from the operation shank, and a first slot extends between the connection end and the distal end along a first longitudinal direction. The second segment may have a first end, a second end and a second slot between the first and second ends. At a first use position, the second end may be adjacent to the connection end of the first segment, and the second segment may be connected to the first slot in a manner that allows the second segment to move in a first direction and a second direction opposite to the first direction. At the first use position, the second segment and the first segment may substantially overlap to form a first L shape, which can be used when a regular torque is needed. In a second use position, the first end of the second segment may extend beyond the distal end of the first segment to form a second L shape with an increased arm length to add a moment arm relative to the connection end which may be used when a large torque is required for instance to loosen a tightened lug nut or fastener of a tire. In a third use position, the second end of the second segment may move beyond the connection end to form a T shape. After loosening a fastener, a T shape configuration is easy to operate with both hands. In another embodiment, by forming the first slot on the side wall of the first segment, the tool may be used at a use position different than the first to third use positions. For example, the tool may be converted to a Z shape to be used like a crank handle. When used to operate a jack, the Z shaped configuration can be easy to use. At the use positions, the operation shank and the first segment may form an angle. The tool according to the present disclosure takes a small space when folded while a large and flexible moment arm can be achieved by varying the configuration of the tool as desired. Although the present disclosure is discussed under the context of a wrench or tool for operating for a jack, the tool may be applied in other mechanical areas where such a tool is needed.

According to one aspect of the disclosure, the tool may include an operation shank, a first segment and a second segment. The first segment may include a connection end coupled to the operation shank, a distal end away from the operation shank, and a first slot extending longitudinally along a first direction. The second segment may include a first end and a second end opposite to the first end, and the second segment is received in the first slot. The second segment is movable in the first direction, so the first end extends beyond the distal end of the first segment, and the second segment is movable in a second direction opposite to the first direction so the second end extends beyond the connection end.

In one embodiment, the second segment may include a second slot parallel to the first slot, and the tool further includes a connector disposed in the first slot and the second slot.

In another embodiment, the connector may include a neck accommodated in the first slot and the second slot, a head and a tail connected to the neck. A dimension of at least a portion of the head and the tail is larger than the width of the first slot and the second slot, so the connector is retained in the first slot and the second slot.

In yet another embodiment, the head of the connector may be disposed external to the second slot and the tail portion of the connector is disposed external to the first slot.

In yet another embodiment, the first slot may extend between the connection end and the distal end. An inner edge of the connection end and an outer edge of the distal end define a longitudinal length of the first slot. The second slot may extend between the first end and the second end, and a first edge of the first end and a second edge of the second end define a longitudinal length of the second slot. When the second segment moves relative to the first segment along the first direction to a first use position the neck of the connector contacts the outer edge and the second edge restricting movement of the second segment. And when the second segment moves along the second direction relative to the first segment to a second use position, the neck of the connector contacts the inner edge and the first edge restricting movement of the first segment.

In yet another embodiment, the connector may have an H shaped cross section.

In yet another embodiment, the operation shank may be pivotably connected to the connection end of the first segment.

In yet another embodiment, the first segment may comprise a bottom wall, a first side wall and an opposing second side wall both connecting to the bottom wall.

In yet another embodiment, the connection end may comprise two supporting walls, each of which may extend from the first and second side walls along a direction away from the bottom wall. The operation shank may be pivotably connected to the two supporting walls.

In yet another embodiment, at a use position, the operation shank may be connected to the two supporting walls so a bottom end of the operation shank and the bottom wall of the first segment define a predetermined distance allowing the second segment to pass through.

In yet another embodiment, the distal end of the first segment may include a distal handle portion defining a top plane parallel to the bottom wall, and the top plane is formed by folding the first wall and second wall toward each other. In a plane perpendicular to the first direction the distal handle portion may have a rectangular cross-section not completely closed.

In yet another embodiment, the first slot may be formed on the bottom wall, and the second segment moves relative to the first segment and is accommodated in the first segment.

In yet another embodiment, the first and second ends of the second segment each may include a first handle and a second handle, the first handle and the second handle each may have a bottom wall, two side walls, and a top panel. In a plane perpendicular to the first direction the first and second handles each have a rectangular cross-section that is not completely closed.

In yet another embodiment, the first slot may be formed on the first side wall, and the second segment may be movably connected to the first side wall via a connector in the first slot, and the second segment may be movable and pivotable to the first segment. The connector may have a shaft, a head and a tail connected to the shaft. The shaft is received in the first slot and the second slot and the head and the tail retain the connector in the first and second slots.

In yet another embodiment, at least one of the head and the tail may be coupled to the connector via a thread connection and loosening the thread connection may enable movement of the connector, while tightening the thread connection may allow the first segment and second segment to be relatively fixed at a desired position.

According to another aspect of the disclosure, a tool is provided to tighten, loosen or hold a fastener. The tool may include an operation shank to accommodate the fastener, a first segment, and a second segment. The first segment may have a connection end coupled to the operation shank, a distal end away from the operation shank, and a first slot extending between the connection end and the distal end in a first direction along a length of the first segment. The second segment may have a first end, a second end and a second slot between the first and second ends. In a first use position, the second end may be adjacent to the connection end of the first segment, and the second segment may be connected to the first segment and movable in the first direction and a second direction opposite to the first direction. In the first use position, the second segment and the first segment may substantially overlap to form a first L shape. In a second use position, the first end of the second segment may extend beyond the distal end of the first segment to form a second L shape with a greater arm length to increase a moment arm relative to the connection end. In a third use position, the second end of the second segment may slide beyond the connection end to form a T shape. The operation shank and the first segment may form an angle at the first, second and third use positions.

In one embodiment, the first segment may include a bottom wall with the first slot disposed in the bottom wall. The second slot is substantially parallel to the first slot, and the tool may further include a connector connected between the first slot and the second slot. The connector has an H shaped cross section allowing the second segment to move along the first slot so the second segment may be retained at the first, second and third use positions.

In yet another embodiment, the tool may further comprise a lock mechanism to retain the second segment at any other use positions different from the first, second and third use positions.

In another embodiment, the first segment may include a bottom wall and a side wall, and the first slot may be formed on the side wall. The second segment may be substantially parallel to the first slot, and the second segment may be movably connected to the side wall via a connector received in the first slot. And the second segment may be movable and pivotable to the first segment. In a fourth use position, the second end of the second segment may be adjacent to the distal end of the first segment, while the first end may be away from the distal end, and the operation shank, the first segment and the second segment may form a Z shape.

In another embodiment, the connector may include a shaft received in the first slot and the second slot, and a head and a tail each connected to the shaft to retain the connector in the first slot and the second slot. At least one of the head and the tail may be coupled to the shaft via a thread connection. And loosening the thread connection may enable movement of the connector, while tightening the thread connection may allow the first segment and the second segment being fixed at a desired position.

Those who are skilled in the art will readily recognize from such discussion, and from the drawings and claims that various changes, modifications and variations can be made without departing from the true spirit and fair scope of the invention as defined by the following claims. The following claims may refer to “an” element or “a first” element or the equivalent thereof. Such claims should be understood to include incorporation of one or more such elements, neither requiring nor excluding two or more such elements. Other combinations and sub-combinations of the disclosed features, functions, elements, and/or properties may be claimed through amendment of the present claims or through presentation of new claims in this or a related application. Such claims, whether broader, narrower, equal, or different in scope to the original claims, also are regarded as included within the subject matter of the present disclosure.

The description of the invention is merely exemplary in nature and, thus, variations that do not depart from the gist of the invention are intended to be within the scope of the invention. Such variations are not to be regarded as a departure from the spirit and scope of the invention.

What is claimed is:

1. A tool comprising:
an operation shank;
a first segment including a connection end coupled to the operation shank, a distal end spaced from the operation shank, and a first slot extending longitudinally in a first direction;
a second segment including a first end and a second end opposite the first end, the second segment movable in relation to the first segment in the direction of the first slot and wherein the second segment moves in the first direction so the first end extends beyond the distal end of the first segment, and the second segment is movable in a second direction opposite to the first direction so the second end extends beyond the connection end.

2. The tool of claim 1 wherein the second segment includes a slot parallel to the first slot; and
said tool further includes a connector disposed in the first slot and the second slot.

3. The tool of claim 2 wherein the connector includes a neck received in the first slot and the second slot, a head and a tail connected to the neck, wherein a dimension of at least a portion of the head and the tail is larger than a width of the first slot and the second slot so the connector is retained in the first slot and the second slot.

4. The tool of claim 3 wherein the head of the connector is disposed external to the second slot and the tail of the connector is disposed external to the first slot.

5. The tool of claim 3 wherein the first slot extends between the connection end and the distal end;
an inner edge of the connection end and an outer edge of the distal end define a length of the first slot;
the second slot extends between the first end and the second end wherein a first edge of the first end and a second edge of the second end define a longitudinal length of the second slot wherein when the second segment moves relative to the first segment in the first direction to a first use position the neck of the connector contacts the outer edge and the second edge to restrict further movement of the second segment; and
the second segment moves in the second direction relative to the first segment to a second use position and the neck of the connector contacts the inner edge and the first edge to restrict further movement of the first segment.

6. The tool of claim 3 wherein the connector has an H shaped cross section.

7. The tool of claim 1 wherein the operation shank is pivotably connected to the connection end of the first segment.

8. The tool of claim 1 wherein the first segment includes a bottom wall and a first side wall and an opposing second side wall both connecting to the bottom wall.

9. The tool of claim 8 wherein the connection end includes two supporting walls, each of which extends from the first and second wall in a direction away from the bottom wall, the operation shank pivotably connected to the two supporting walls.

10. The tool of claim 9 wherein in a use position the operation shank is connected to the two supporting walls so a bottom end of the operation shank and the bottom wall of the first segment define a predetermined distance allowing the second segment to pass through and between the operation shank and the bottom wall of the first segment.

11. The tool of claim 10 wherein the distal end of the first segment includes a distal handle portion, the distal handle portion formed by folding an extended portion of the first wall and an extended portion of the second wall toward each other; and in a plane perpendicular to the first direction the distal handle portion has a rectangular cross-section that is not completely closed.

12. The tool of claim 8, wherein the first slot is formed on the bottom wall, and the second segment is movable to the first segment and completely received in the first segment.

13. The tool of claim 8 including a first handle at the first end of the second segment and a second handle at the second end of the second segment each of the first handle and the second handle has a bottom wall, two side walls and a top wall, and in a plane perpendicular to the first direction, the first and second handles have a rectangular cross-section that is not completely closed.

14. The tool of claim 8 wherein the first slot is formed on the first side wall, and the second segment is movably connected to the first side wall via a connector in the first slot, and the second segment is movable and pivotable relative to the first segment wherein the connector has a shaft received in the first slot and the second slot, and a head and a tail connected to the shaft to retain the connector in the first and second slots.

15. The tool of claim 14 including at least one of the head and the tail of the connector coupled to the shaft via a thread connection, and wherein loosening the thread connection enables movement of the connector in the respective first and second slots while tightening the thread connection fixes the first segment and second segment at a desired position.

16. A tool to tighten, loosen or hold a fastener, comprising:
an operation shank to accommodate the fastener;
a first segment having a connection end coupled to the operation shank, a distal end spaced from the operation shank, and a first slot between the connection end and the distal end;
a second segment having a first end, a second end, and a second slot between the first and second ends, wherein in a first use position the second end of the second segment is adjacent to the connection end of the first segment and the second segment is connected to the first segment and movable in a first direction and a second direction opposite the first direction;
wherein in the first use position the second segment and the first segment substantially overlap to form a first L shape, in a second use position the first end of the second segment extends beyond the distal end of the first segment to form a second L shape with a greater length to increase a moment arm relative to the connection end, and in a third use position the second end of the second segment moves beyond the connection end to form a T shape wherein the operation shank and the first segment form an angle at the first, second and third use positions.

17. The tool of claim 16 wherein the first segment includes a bottom wall and the first slot is disposed in the bottom wall and the second slot is substantially parallel to the first slot wherein the tool further includes a connector connected between the first slot and the second slot, the connector having an H shaped cross section allowing the second segment to move relative to the first segment and to retain the second segment at the first, second and third use positions.

18. The tool of claim 16 wherein the first segment includes a bottom wall and a side wall and the first slot is formed in the side wall and the second segment is substantially parallel to the first slot, the second segment movably connected to the side wall via a connector received in the first slot, and the second segment movable and pivotable relative to the first segment, wherein in a fourth use position the second end of the second segment is adjacent to the distal end of the first segment, the first end is away from the distal end, and wherein the operation shank, the first segment and the second segment are perpendicular to one another.

19. The tool of claim 16 wherein the connector includes a shaft received in the first slot and the second slot and a head and a tail connected to the shaft to retain the connector in the first slot and the second slot wherein at least one of the head and the tail is coupled to the shaft via a thread connection and loosening the thread connection enables movement of the connector in the respective first and second slots while tightening the thread connection allows the first segment and the second segment being fixed at a desired position.

20. A tool comprising:
an operation shank;
a first segment having a bottom wall and a first side wall and an opposing second side wall each connected to the bottom wall, said first segment having a connection end coupled to the operation shank, a distal end spaced from the operation shank and a slot in said bottom wall and extending longitudinally between said connection end and said distal end;
a second segment having a first end and a second end opposite the first end, said second segment adjacent said bottom wall and between said first and second side walls, said second segment having a slot, said second segment slot located adjacent said first segment slot;
a connector extending through said first segment slot and said second segment slot; and
said second segment movable with respect to said first segment wherein said second segment moves between a first position wherein second segment moves in the longitudinal direction of said first segment slot so the first end extends beyond the distal end of the first segment and a second position wherein the second segment moves in the longitudinal direction of said first segment slot so the second end extends beyond the connection end.
